(19) United States
(12) Patent Application Publication
(10) Pub. No.: US 2015/0361865 A1
(43) Pub. Date: Dec. 17, 2015

(54) Engine System having Multi Flow Rate Control Valve

(71) Applicant: Hyundai Motor Company, Seoul (KR)

(72) Inventor: Hyojo LEE, Suwon-Si (KR)

(73) Assignee: Hyundai Motor Company, Seoul (KR)

(21) Appl. No.: 14/525,644

(22) Filed: Oct. 28, 2014

(30) Foreign Application Priority Data
Jun. 16, 2014 (KR) 10-2014-0073081

(51) Int. Cl. F01P 7/14; F02M 25/07

(52) U.S. Cl. CPC F01P 7/14; F02M 25/0726

(57) ABSTRACT

An engine system having a control valve may include a multi flow rate control valve that circulates a coolant supplied a side of the multi flow rate control valve to at least two heat exchangers, a pressure cap that is connected to a supply line, which connects the multi flow rate control valve to the at least two heat exchangers, and is operated by a pressure that is transferred from the supply line to release the pressure or exhaust the coolant through an outlet, a reservoir tank that is mounted at one side of the pressure cap and is formed to house the coolant exhausted from the pressure cap, and a connection line that connects the outlet with the reservoir tank to release the pressure from the pressure cap or exhaust the coolant from the pressure cap.

### CROSS-REFERENCE TO RELATED APPLICATION

The present application claims priority of Korean Patent Application Number 10-2014-0073081 filed on Jun. 16, 2014, the entire contents of which application are incorporated herein for all purposes by this reference.

### BACKGROUND OF INVENTION

1. Field of Invention

The present invention relates to an engine system having a multi flow rate control valve that respectively controls coolant passing an engine, a radiator, a heater core, and an EGR cooler to be able to improve cooling efficiency and fuel consumption efficiency.

2. Description of Related Art

The engine generates a torque by burning fuel, and exhausts the remainder in thermal energy. Particularly, cooling water absorbs heat while circulating the engine, a heater and a radiator and dissipates the heat to an outside of the engine.

If a cooling water temperature of the engine is low to elevate oil viscosity, it is a trend that friction force and fuel consumption increases and a temperature of exhaust gas rises slowly resulting to prolong a time period of catalyst activation to make a quality of the exhaust gas poor. Along with this, there is a trend that a time period for bringing a heater function to a normal level takes a long time to make occupants and a driver to feel cold.

If the cooling water temperature of the engine is excessive, knocking takes place, and, if ignition timing is adjusted for suppressing the knocking, performance is liable to become poor. And, if a lubrication oil temperature is excessive, a lubrication action is liable to become poor.

Accordingly, a temperature of a specific section of an engine is maintained to be high and that of other section of the engine is maintained to be low, wherein one integrated flow rate valve is used to control several cooling elements.

Particularly, a pressure cap is disposed at an upper end of the radiator, the pressure cap controls the coolant pressure of the cooling system, and the coolant is supplemented through the pressure cap. However, because one integrated flow rate valve is used to control coolant that is supplied to a heater core, an EGR cooler, and a radiator, it is hard to quickly control the pressure of the coolant and it is hard to quickly supplement the coolant.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an engine system having a multi flow rate control valve having advantages of quickly controlling pressure of coolant line and quickly supplementing coolant, when controlling coolant that is supplied to heat exchanger for cooling and heating through a multi flow rate control valve.

An engine system having a control valve according to various aspects of the present invention may include a multi flow rate control valve that circulates a coolant supplied a side of the multi flow rate control valve to at least two heat exchangers, a pressure cap that is connected to a supply line, which connects the multi flow rate control valve to the at least two heat exchangers, and is operated by a pressure that is transferred from the supply line to release the pressure or exhaust the coolant through an outlet, a reservoir tank that is mounted at one side of the pressure cap and is formed to house the coolant exhausted from the pressure cap, and a connection line that connects the outlet with the reservoir tank to release the pressure from the pressure cap or exhaust the coolant from the pressure cap.

A heat exchanger in the at least two heat exchangers may include a heater core that is configured to increase interior air temperature by heating outside air, an EGR cooler that is configured to cool EGR gas recirculated from an exhaust line to an intake line, or a radiator that is configured to cool the coolant by exchanging heat with the outside air.

The multi flow rate control valve may include a valve housing that is formed with a mounting space, a cylindrical valve that is rotatably disposed in the mounting space, and has a space formed in a central portion of the cylindrical valve and in a length direction of the cylindrical valve, and a coolant passage formed from the space to an exterior surface of the cylindrical valve, and a drive portion that is configured to rotate the cylindrical valve such that the coolant passage is connected to the supply line.

The multi flow rate control valve may include a sealing member having a pipe shape for insertion of a front end portion of the supply line, wherein an end portion surface of the sealing member slidably contacts an exterior circumference of the cylindrical valve to form a sealing structure, and an elastic member that elastically pushes the sealing member toward the exterior circumference of the cylindrical valve.

Coolant circulated an engine may be supplied to the multi flow rate control valve and the coolant may be supplied to the heater core, the EGR cooler, or the radiator depending on an operational state of the multi flow rate control valve.

The pressure cap may include a cap housing that a lower portion thereof is connected to the supply line, a piston that is movably disposed in the cap housing, wherein movement of the piston depends on the pressure of the supply line, a pressure spring that elastically pushes the piston, a pressure valve that is disposed on the piston and is operated by the pressure of the supply line, the outlet that releases pressure or coolant supplied from the piston or the pressure valve, and a cap that is engaged with the outlet that is formed at an upper portion of the cap housing and supports the pressure spring.

The supply line may include a first supply line that connects the multi flow rate control valve with the heater core so as to transfer the coolant, a second supply line that connects the multi flow rate control valve with the EGR cooler so as to transfer the coolant, and a third supply line that connects the multi flow rate control valve with the radiator so as to transfer the coolant.

One side of the reservoir tank may be opened to an outside and the reservoir tank has a storage space for storing the coolant. The pressure cap is configured such that the pressure of the coolant line is less than a predetermined value that is higher than atmospheric pressure.

In accordance with the present invention, a pressure cap is connected to coolant lines that are respectively supplied to a heater core, a radiator, and an EGR cooler such that the coolant is quickly supplemented and bubble that is included in the coolant can be quickly exhausted.

Also, because a pressure cap release pressure to a reservoir tank depending on a pressure or a temperature condition around a multi flow rate control valve, damage of a multi flow rate control valve is prevented and overall coolant pressure and temperature can be quickly and accurately controlled.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an overall schematic diagram of an engine system having a multi flow rate control valve that is related to the present invention.

FIG. 2 is an overall schematic diagram of an engine system having an exemplary multi flow rate control valve according to the present invention.

FIG. 3 is a cross-sectional view of an exemplary multi flow rate control valve according to the present invention.

FIG. 4 is a cross-sectional view of an exemplary pressure cap according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

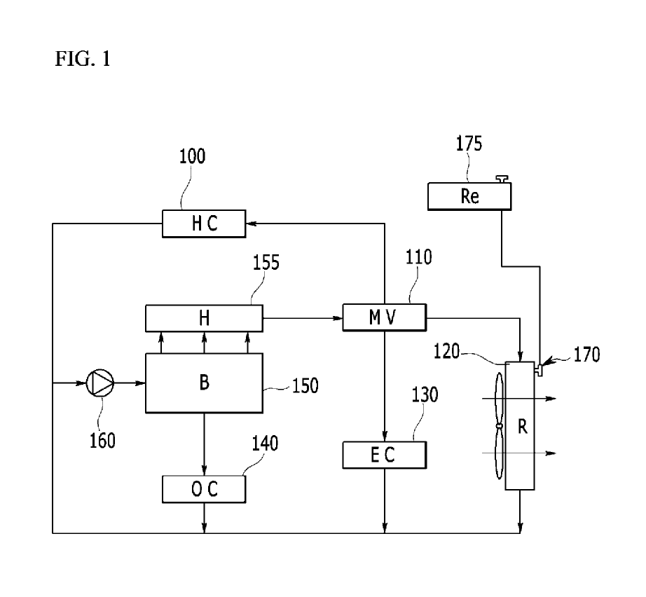

FIG. 1 is an overall schematic diagram of an engine system having a multi flow rate control valve that is related to the present invention. Referring to FIG. 1, an engine system includes a cylinder block 150, a cylinder head 155, a multi flow rate control valve 110, an EGR cooler 130, an oil cooler 140, a coolant pump 160, a heater core 100, a radiator 120, a pressure cap 170, and a reservoir tank 175.

Coolant that is pumped by the coolant pump 160 passes the cylinder block 150 and the cylinder head 155 to be supplied to the multi flow rate control valve 110. The multi flow rate control valve 110 controls the coolant that is respectively supplied to the heater core 100, the EGR cooler 130, and the radiator 120. The coolant passing the heater core 100, the EGR cooler 130, or the radiator 120 is supplied to the coolant pump 160 and circulates an engine system.

A pressure cap 170 is disposed at one side of the radiator 120, the pressure cap 170 functions as a cap and also performs releasing the pressure of coolant passing the radiator 120 to the reservoir tank 175. A predetermined level of coolant is filled in the reservoir tank 175, the coolant that is supplied to the radiator 120 through the pressure cap 170 is stored in the tank 175.

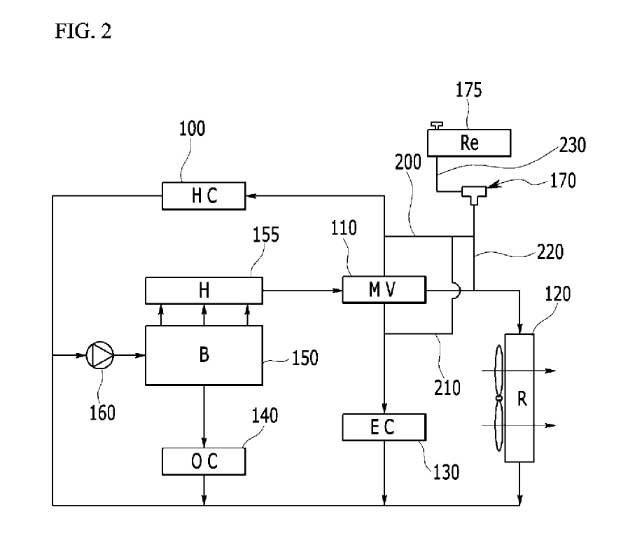

FIG. 2 is an overall schematic diagram of an engine system having a multi flow rate control valve according to various embodiments of the present invention. Referring to FIG. 2, an engine system includes a coolant pump 160, a cylinder block 150, a cylinder head 155, a multi flow rate control valve 110, a heater core 100, an EGR cooler 130, a radiator 120, a pressure cap 170, and a reservoir tank 175, and includes a first diverging line 200, a second diverging line 210, a third diverging line 220, and a connection line 230.

The first diverging line 200 is diverged from the first supply line 330 that is connected from the multi flow rate control valve 110 to the heater core 100, the second diverging line 210 is diverged from the second supply line 335 that is connected from the multi flow rate control valve 110 to the EGR cooler 130, and the third diverging line 220 is diverged from the third supply line 340 that is connected from the multi flow rate control valve 110 to the radiator 120.

The first diverging line 200, the second diverging line 210, and the third diverging line 220 join to one line and the joined line is connected to the pressure cap 170. One side of the pressure cap 170 is connected to the reservoir tank 175 through the connection line 230.

In various embodiments of the present invention, the pressure cap 170 is respectively connected to the supply lines that are connected the heater core 100, the radiator 120, and the EGR cooler 130 through the first diverging line 200, the second diverging line 210, and the third diverging line 220 such that the coolant is quickly supplemented and the bubble that is included in the coolant is quickly exhausted.

Depending on the temperature or the pressure around the multi flow rate control valve 110, because the pressure cap 170 releases the pressure to the reservoir tank 175, the damage of the multi flow rate control valve 110 is prevented, and overall coolant pressure and temperature can be quickly and accurately controlled.

Generally, in case that the pressure cap 170 is disposed on a radiator, the pressure of the radiator 120 is relatively quickly controlled, but the pressure of the overall cooling system cannot be efficiently controlled.

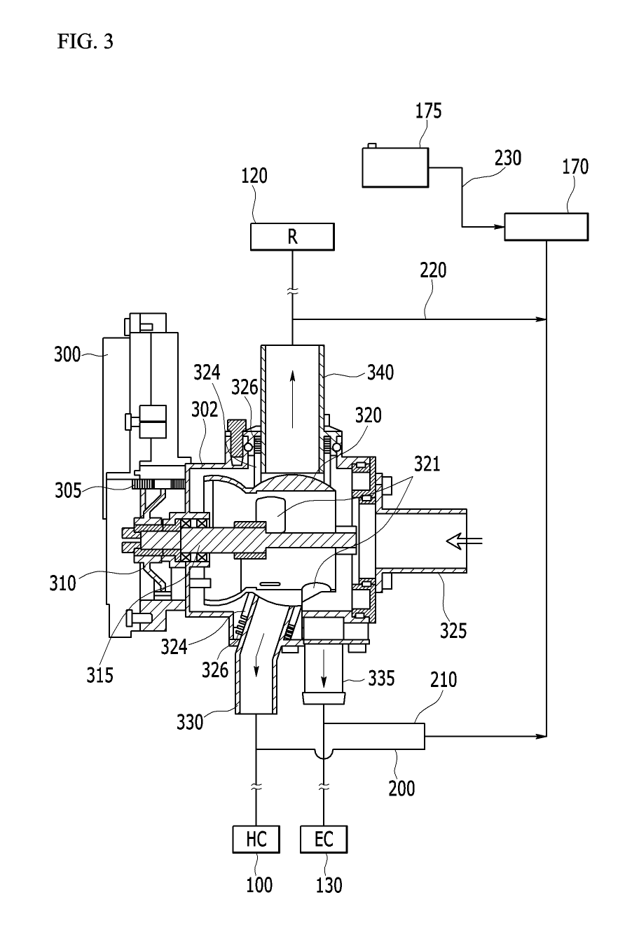

FIG. 3 is a cross-sectional view of a multi flow rate control valve according to various embodiments of the present invention. Referring to FIG. 3, a multi flow rate control valve 110 includes a motor housing 300, an output gear 305, a driven gear 310, a rotation shaft 315, a valve housing 302, a cylindrical valve 320, a sealing member 324, and an elastic member 326, and is respectively connected to a coolant inlet 325, a third supply line 340, a first supply line 330, and a second supply line 335.

The coolant that is supplied from the cylinder head 155 through the coolant inlet 325 flows to a central portion of the cylindrical valve 320. And, a coolant passage 321 is formed such that the coolant flows from the central portion to an exterior surface of the cylindrical valve 320. The third supply line 340, the first supply line 330, and the second supply line 335 are disposed on the valve housing 302 corresponding to the coolant passage 321.

If the output gear 305 is rotated by a motor that is disposed inside the motor housing 300, the driven gear 310 rotates, and if the rotation shaft 315 that is connected to the driven gear 310 rotates, the cylindrical valve 320 rotates.

In accordance with the rotation of the cylindrical valve 320, the coolant passage 321 corresponds to the third supply line 340, the first supply line 330, or the second supply line 335, and the coolant is selectively supplied to the radiator 120, the heater core 100, or the EGR cooler 130.

A sealing member 324 and an elastic member 326 are disposed between the supply lines and an exterior circumference of the cylindrical valve 320 The sealing member 324 has a short pipe shape, one end of the supply line is inserted into the member 324, a front end surface of the sealing member 324 contacts an exterior circumference of the cylindrical valve 320, the elastic member 326 elastically pushes the sealing member 324 toward the cylindrical valve such that the sealing member 324 forms a sealing structure with the cylindrical valve 320.

Also, the pressure cap 170 is connected to the reservoir tank 175 through the connection line 230, retrieves the coolant that overflows the pressure cap 170 to the reservoir tank 175, and supplements lacking coolant from the reservoir tank 175 to the cooling system.

The pressure cap 170 is respectively connected to a supply line that is connected to the radiator 12, to a supply line that is connected to the heater core 100, and a supply line that is connected to the EGR cooler 130 such that overall coolant pressure is quickly and efficiently controlled. Further, while the coolant is being supplemented through the pressure cap 170, the coolant is quickly and efficiently supplemented.

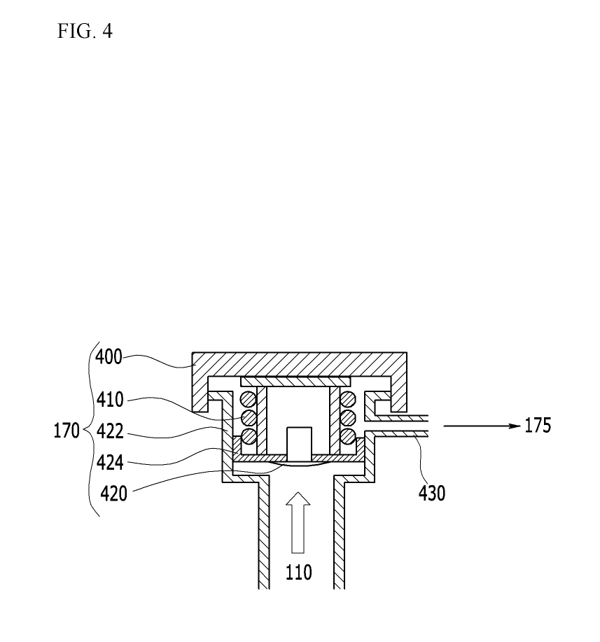

FIG. 4 is a cross-sectional view of a pressure cap according to various embodiments of the present invention. The pressure cap 170 includes a cap 400, a pressure spring 410, a cap housing 422, a piston 424, a pressure valve 420, and an outlet 430. A lower portion of the cap housing 422 is connected to the multi flow rate control valve 110, and a side surface is connected to the reservoir tank 175 to form an outlet 430.

A piston 424 is disposed inside the cap housing 422, and a pressure valve 420 that releases pressure or allows the coolant to pass is disposed in a middle or middle portion of the piston 424.

In a condition that the cap 400 is engaged with the cap housing 422, the pressure spring 410 elastically pushes the piston 424 downwards to prevent the coolant from being exhausted through the outlet 430, and while the pressure of the coolant is being increased, the piston 424 moves upwards, the pressure spring 410 is compressed. Further, when the coolant of the multi flow rate control valve 110 is lacking, the coolant can be supplied through the outlet 430 and the pressure valve 420.

For convenience in explanation and accurate definition in the appended claims, the terms “upper” or “lower”, “upward” or “downward”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine system having a control valve, comprising:
a multi flow rate control valve that circulates a coolant supplied a side of the multi flow rate control valve to at least two heat exchangers;
a pressure cap that is connected to a supply line, which connects the multi flow rate control valve to the at least two heat exchangers, and is operated by a pressure that is transferred from the supply line to release the pressure or exhaust the coolant through an outlet;
a reservoir tank that is mounted at one side of the pressure cap and is formed to house the coolant exhausted from the pressure cap; and
a connection line that connects the outlet with the reservoir tank to release the pressure from the pressure cap or exhaust the coolant from the pressure cap.

2. The engine system having a control valve of claim 1, wherein a heat exchanger in the at least two heat exchangers includes:
a heater core that is configured to increase interior air temperature by heating outside air;
an EGR cooler that is configured to cool EGR gas recirculated from an exhaust line to an intake line; or
a radiator that is configured to cool the coolant by exchanging heat with the outside air.

3. The engine system having a control valve of claim 1, wherein the multi flow rate control valve includes:
a valve housing that is formed with a mounting space;
a cylindrical valve that is rotatably disposed in the mounting space, and has a space formed in a central portion of the cylindrical valve and in a length direction of the cylindrical valve, and a coolant passage formed from the space to an exterior surface of the cylindrical valve; and
a drive portion that is configured to rotate the cylindrical valve such that the coolant passage is connected to the supply line.

4. The engine system having a control valve of claim 3, wherein the multi flow rate control valve comprising:
a sealing member having a pipe shape for insertion of a front end portion of the supply line, wherein an end portion surface of the sealing member slidably contacts an exterior circumference of the cylindrical valve to form a sealing structure; and
an elastic member that elastically pushes the sealing member toward the exterior circumference of the cylindrical valve.

5. The engine system having a control valve of claim 2, wherein coolant circulated an engine is supplied to the multi flow rate control valve and the coolant is supplied to the heater core, the EGR cooler, or the radiator depending on an operational state of the multi flow rate control valve.

6. The engine system having a control valve of claim 2, wherein the pressure cap includes:
a cap housing that a lower portion thereof is connected to the supply line;
a piston that is movably disposed in the cap housing, wherein movement of the piston depends on the pressure of the supply line;
a pressure spring that elastically pushes the piston;
a pressure valve that is disposed on the piston and is operated by the pressure of the supply line;
the outlet that releases pressure or coolant supplied from the piston or the pressure valve; and
a cap that is engaged with the outlet that is formed at an upper portion of the cap housing and supports the pressure spring.

7. The engine system having a control valve of claim 2, wherein the supply line includes:
a first supply line that connects the multi flow rate control valve with the heater core so as to transfer the coolant;
a second supply line that connects the multi flow rate control valve with the EGR cooler so as to transfer the coolant; and
a third supply line that connects the multi flow rate control valve with the radiator so as to transfer the coolant.

8. The engine system having a control valve of claim 2, wherein one side of the reservoir tank is opened to an outside and the reservoir tank has a storage space for storing the coolant.

9. The engine system having a control valve of claim 1, wherein the pressure cap is configured such that the pressure of the coolant line is less than a predetermined value that is higher than atmospheric pressure.
